(19) United States
(12) Patent Application Publication
(10) Pub. No.: US 2014/0016709 A1
(43) Pub. Date: Jan. 16, 2014

(54) IMAGE SYSTEM

(71) Applicant: OPTICIS CO., LTD., Sungnam-si (KR)

(72) Inventors: Jae-Chul KO, Gwangju-si (KR); Doo Soo HA, Seongnam-si (KR)

(73) Assignee: OPTICIS CO., LTD., Sungnam-si (KR)

(21) Appl. No.: 13/840,894

(22) Filed: Mar. 15, 2013

(30) Foreign Application Priority Data
Jul. 16, 2012 (KR) 10-2012-0077317

(51) Int. Cl. H04N 7/01

(52) U.S. Cl. CPC H04N 7/0125
USPC 375/240.25; 348/441

(57) ABSTRACT

An image system includes image signal generating apparatuses; display apparatuses; and intervention apparatuses. The intervention apparatuses are interconnected between the image signal generating apparatuses and the display apparatuses, convert the image signals from the image signal generating apparatuses to image signals of a first format, add identification information regarding the image signal generating apparatuses to the image signals of the first format, and output the image signals of the first format and the identification information, respectively.

### CROSS-REFERENCE TO RELATED PATENT APPLICATION

This application claims the benefit of Korean Patent Application No. 10-2012-77317, filed on Jul. 16, 2012, in the Korean Intellectual Property Office, the disclosure of which is incorporated herein in its entirety by reference.

### BACKGROUND OF THE INVENTION

1. Field of the Invention

The present invention relates to an image system, and more particularly, to an image system including image signal generating apparatuses and display apparatuses.

2. Description of the Related Art

FIG. 1 shows a common image system.

Referring to FIG. 1, the common image system includes image signal generating apparatuses 101 through 10n and display apparatuses 111 through 11n which correspond to the image signal generating apparatuses 101 through 10n, respectively.

For example, an image system for a hospital include a plurality of image signal generating apparatuses 101 through 10n that are respectively combined with medical equipments and a plurality of display apparatuses 111 through 11n which correspond to the plurality of image signal generating apparatuses 101 through 10n, respectively.

In the image system as stated above, since formats of image signals generated by the image signal generating apparatuses 101 through 10n are different from one another, types of the display apparatuses 111 through 11n are different from one another. Furthermore, if the display apparatuses 111 through 11n are the same type of display apparatuses 111 through 11n, it is necessary for each of the display apparatuses 111 through 11n to be able to display various types of image signals.

Therefore, a convention image system inefficiently utilizes display apparatuses, and it is difficult to jointly control the display apparatuses.

To resolve the problem, if formats of image signals generated by a plurality of image signal generating apparatuses are converted to a same format, it is difficult to determine a particular image signal generating apparatus to which a particular display apparatus is to be connected or is connected.

### SUMMARY OF THE INVENTION

The present invention provides an image system which enables efficient utilization of display apparatuses, easy joint control of the display apparatuses, and easy determination of a particular image signal generating apparatus to which a particular display apparatus is to be connected or is connected.

According to an aspect of the present invention, there is provided an image system including image signal generating apparatuses, which generate image signals of different formats; display apparatuses, which receive and display the image signals from the image signal generating apparatuses, respectively; and intervention apparatuses, which are interconnected between the image signal generating apparatuses and the display apparatuses, convert the image signals from the image signal generating apparatuses to image signals of a first format, add identification information regarding the image signal generating apparatuses to the image signals of the first format, and output the image signals of the first format and the identification information, respectively.

Each of the intervention unit includes a transmission intervention unit and a reception intervention unit that are connected to each other. The transmission intervention unit is connected to the corresponding one from among the image signal generating apparatuses. The reception intervention unit is connected to the corresponding one from among the display apparatuses.

The transmission intervention unit converts image signals from the corresponding image signal generating apparatus to image signals of the first format, adds identification information regarding the corresponding image signal generating apparatus to the image signals of the first format according to a user input, and transmits the image signals of the first format to the reception intervention unit.

The reception intervention unit finds the identification information in the image signals of the first format from the transmission intervention unit, outputs the identification information, and inputs the image signals of the first format to the display apparatus.

The transmission intervention unit includes an input image decoder, which decodes image signals from a corresponding image signal generating apparatus; a image signal converting unit, which converts the decoded image signals from the input image decoder to image signals of the first format, adds identification information regarding the corresponding image signal generating apparatus to the image signals of the first format, and transmits the image signals of the first format to the reception intervention unit; and a first control unit, which communicates with a user interface device and provides the identification information regarding the corresponding image signal generating apparatus to the image signal converting unit according to an input signal from the user interface device.

The reception intervention unit includes an identification information searching unit, which finds identification information included in the image signals of the first format from the image signal converting unit of the transmission intervention unit, outputs the identification information, and provides the image signals of the first format to the display apparatus; and a second control unit, which communicates with a identification information displaying device and provides the identification information from the identification information searching unit to the identification information displaying device.

Image signals of the first format are image signals of high-definition multimedia interface (HDMI) format that are encoded in transition minimized differential signalling (TMDS) method

The transmission intervention unit includes an input image decoder, which decodes image signals from the corresponding image signal generating apparatus; a first HDMI encoder, which converts the decoded image signals from the input image decoder to image signals of the HDMI format, adds identification information regarding the corresponding image signal generating apparatus to the image signals of the HDMI format by using the TMDS method, and transmits the image signals of the HDMI format to the reception intervention unit; and a first control unit, which communicates with a user input apparatus and provides the identification information regarding the corresponding image signal generating apparatus to the first HDMI encoder according to an input signal from the user input apparatus.

The reception intervention unit includes a HDMI decoder, which decodes the image signals of the HDMI format from the first HDMI encoder, finds identification information included in the image signals of the HDMI format, outputs the identification information, and outputs the decoded image signals of the HDMI format; a second HDMI encoder, which encodes the decoded image signals of the HDMI format from the HDMI decoder by using the TMDS method and provides the encoded image signals to the display apparatus; and a second control unit, which communicates with a identification information displaying device and provides the identification information from the HDMI decoder to the identification information displaying device.

The identification information regarding the corresponding image signal generating apparatus is added to at least one of info-frame regions providing information regarding various data and unrecognized packet regions in the decoded HDMI format.

The information regarding various data include information regarding audio video interleave (AVI) data, information regarding source produce descriptor (SPD) data, information regarding audio data, and information regarding moving picture experts group (MPEG) data.

A unit image frame of HDMI format encoded by using the TMDS method includes control sections, data island sections, and video data sections. Here, the identification information regarding the corresponding image signal generating apparatus is added to the data island sections.

Furthermore, an image signal of the HDMI format encoded by using the TMDS method is transmitted via 3 data channels and 1 clock channel, where a unit frame of the image signal is transmitted in the order of control period, data island period, control period, and video data period. Here, the identification information regarding the corresponding image signal generating apparatus is added to data island period.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a common image system;

FIG. 2 is a block diagram showing an image system according to an embodiment of the present invention;

FIG. 3 is a block diagram showing the configuration of an arbitrary intervention apparatus of FIG. 2;

FIG. 4 is a block diagram showing a first example configuration of a transmission intervention unit of FIG. 3;

FIG. 5 is a block diagram showing a first example configuration of a reception intervention unit of FIG. 3;

FIG. 6 is a block diagram showing a second example configuration of the transmission intervention unit of FIG. 3;

FIG. 7 is a block diagram showing a second example configuration of the reception intervention unit of FIG. 3;

FIG. 8 shows a unit image frame of HDMI format encoded by using the transition minimized differential signalling (TMDS) method; and

FIG. 9 shows the structure of an image signal of HDMI format encoded by using the TMDS method.

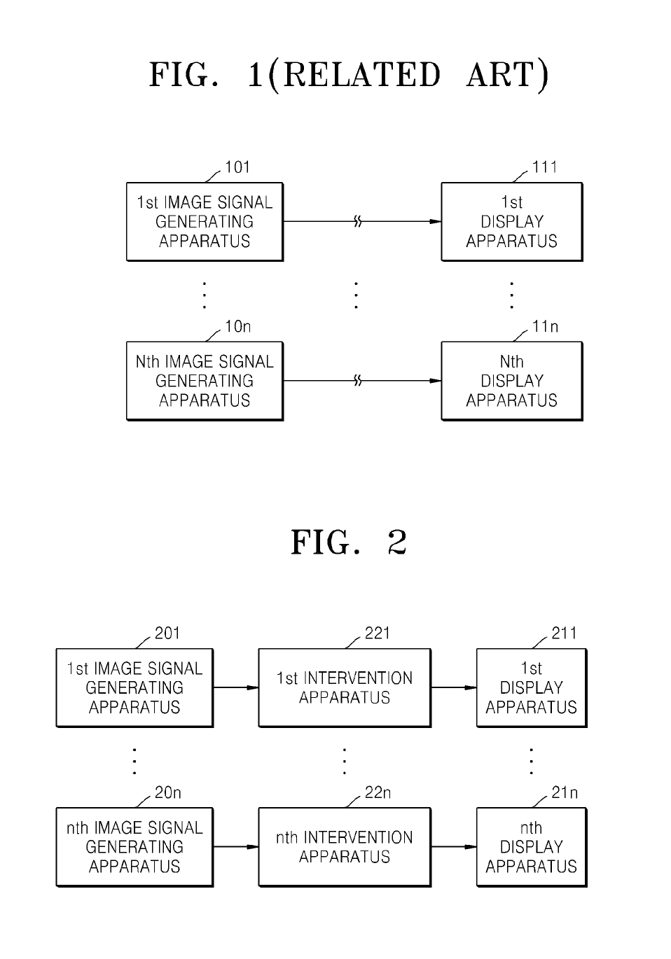

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention. Hereinafter, the present invention will be described in detail by explaining exemplary embodiments of the invention with reference to the attached drawings. Like reference numerals in the drawings denote like elements. Expressions such as “at least one of,” when preceding a list of elements, modify the entire list of elements and do not modify the individual elements of the list.

FIG. 2 shows an image system according to an embodiment of the present invention, the image system according to an embodiment of the present invention includes image signal generating apparatuses 201 through 20n, display apparatuses 211 through 21n, and intervention apparatuses 221 through 22n.

The image signal generating apparatuses 201 through 20n generate image signals of different formats.

The display apparatuses 211 through 21n receive and display the image signals generated by the image signal generating apparatuses 201 through 20n, respectively.

The intervention apparatuses 221 through 22n are interconnected between the image signal generating apparatuses 201 through 20n and the display apparatuses 211 through 21n, respectively.

The intervention apparatuses 221 through 22n convert the image signals from the image signal generating apparatuses 201 through 20n to image signals of a first format, respectively.

Therefore, the display apparatuses 211 through 21n receive and display image signals of the first format only and may be a same type of display apparatuses 211 through 21n. In other words, the display apparatuses 211 through 21n may be utilized efficiently, and it becomes easy to jointly control the display apparatuses 211 through 21n.

Furthermore, the intervention apparatuses 221 through 22n add identification information regarding the image signal generating apparatuses 201 through 20n according to a user input to image signals of the first format and output the image signals of the first format and the identification information, respectively.

Therefore, the problem in a case where the display apparatuses 211 through 21n receive and display image signals of the first format only, that is, the problem that it is difficult for a user to determine a particular image signal generating apparatus to which a particular display apparatus is to be connected or is connected may be resolved.

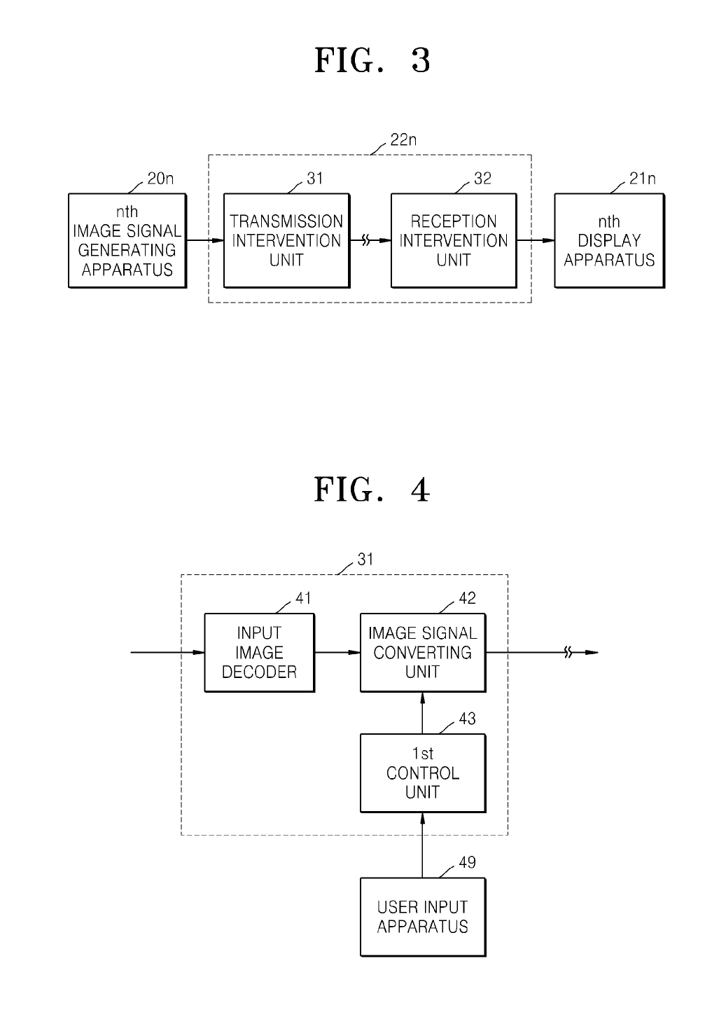

FIG. 3 shows the configuration of the arbitrary intervention apparatus 22n of FIG. 2. In FIG. 3, the like reference numeral denotes the like components.

Referring to FIGS. 2 and 3, the intervention apparatus 20n includes a transmission intervention unit 31 and a reception intervention unit 32 that are connected to each other. The transmission intervention unit 31 is connected to the corresponding one 20n of the image signal generating apparatuses 201 through 20n. The reception intervention unit 32 is connected to the corresponding one 21n of the display apparatuses 211 through 21n.

The transmission intervention unit 31 converts image signals from the corresponding image signal generating apparatus 20n to image signals of the first format, adds identification information regarding the corresponding image signal generating apparatus 20n according to a user input to the image signals of the first format, and transmits the image signals of the first format to the reception intervention unit 32.

The reception intervention unit 32 finds the identification information in the image signals of the first format from the transmission intervention unit 31, outputs the identification information, and inputs the image signals of the first format to the display apparatus 21n.

FIG. 4 shows a first example configuration of the transmission intervention unit 31.

Referring to FIGS. 3 and 4, the transmission intervention unit 31 includes an input image decoder 41, an image signal converting unit 42, and a first control unit 43.

The input image decoder 41 decodes image signals from the corresponding corresponding image signal generating apparatus 20n.

The image signal converting unit 42 converts the decoded image signals from the input image decoder 41 to image signals of the first format, adds identification information regarding the corresponding image signal generating apparatus 20n to the image signals of the first format, and transmits the image signals of the first format to the reception intervention unit 32.

The first control unit 43 communicates with a user input apparatus 49 and provides the identification information regarding the corresponding image signal generating apparatus 20n to the image signal converting unit 42 according to an input signal from the user input apparatus 49.

The user input apparatus 49 may be a laptop computer, for example. The first control unit 43 and the user input apparatus 49 may communicate with each other via a universal serial bus (USB) or universal asynchronous receiver/transmitter (UART).

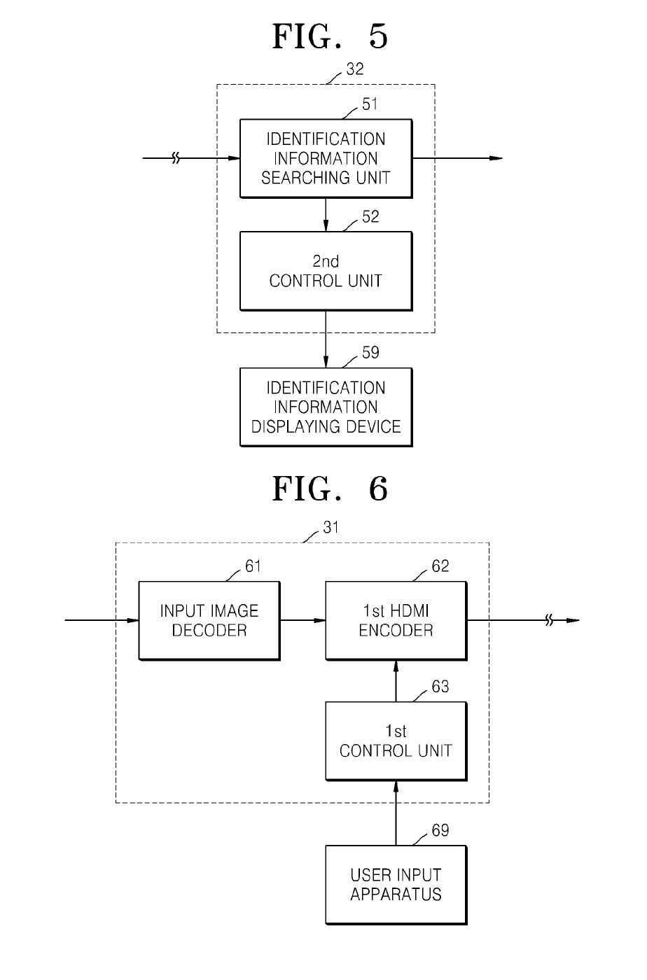

FIG. 5 shows a first example configuration of the reception intervention unit 32 of FIG. 3.

Referring to FIGS. 3 and 5, the reception intervention unit 32 includes an identification information searching unit 51 and a second control unit 52.

The identification information searching unit 51 finds identification information included in the image signals of the first format from the image signal converting unit 42 of the transmission intervention unit 31, outputs the identification information, and provides the image signals of the first format to the display apparatus 21n.

The second control unit 52 communicates with a identification information displaying device 59 and provides the identification information from the identification information searching unit 51 to the identification information displaying device 59.

The identification information displaying device 59 may be a small liquid crystal display (LCD) device, for example. The second control unit 52 and the identification information displaying device 59 may communicate with each other via a USB or UART.

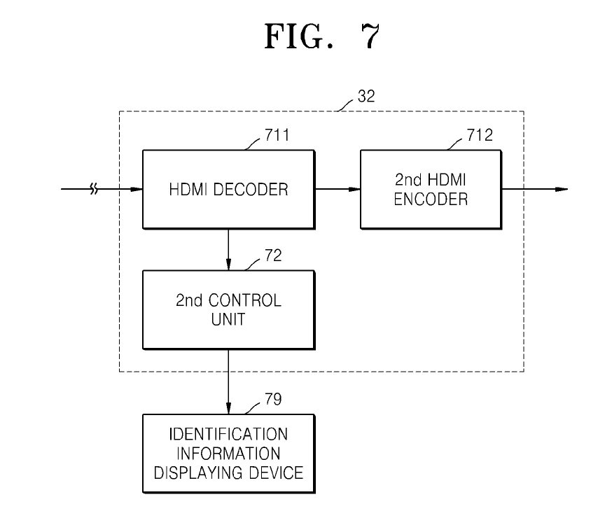

FIG. 6 shows a second example configuration of the transmission intervention unit 31 of FIG. 3. Hereinafter, image signals of the first format are image signals of high-definition multimedia interface (HDMI) format that are encoded in transition minimized differential signalling (TMDS) method.

Referring to FIGS. 3 and 6, the transmission intervention unit 31 of the second example includes an input image decoder 61, a first HDMI encoder 62, and a first control unit 63.

The input image decoder 61 decodes image signals from the corresponding image signal generating apparatus 20n.

The first HDMI encoder 62 converts the decoded image signals from the input image decoder 61 to image signals of the HDMI format, adds identification information regarding the corresponding image signal generating apparatus 20n to the image signals of the HDMI format by using the TMDS method, and transmits the image signals of the HDMI format to the reception intervention unit 32.

The first control unit 63 communicates with a user input apparatus 69 and provides the identification information regarding the corresponding image signal generating apparatus 20n to the first HDMI encoder 62 according to an input signal from the user input apparatus 69.

As described above, the user input apparatus 69 may be a laptop computer, for example. The first control unit 63 and the user input apparatus 69 may communicate with each other via a USB or UART.

FIG. 7 shows a second example configuration of the reception intervention unit 32 of FIG. 3.

Referring to FIGS. 3, 6, and 7, the reception intervention unit 32 includes a HDMI decoder 711, a second HDMI encoder 712, and a second control unit 72.

The HDMI decoder 711 decodes the image signals of the HDMI format from the first HDMI encoder 62, finds identification information included in the image signals of the HDMI format, outputs the identification information, and outputs the decoded image signals of the HDMI format.

The second HDMI encoder 712 encodes the decoded image signals of the HDMI format from the HDMI decoder 711 by using the TMDS method and provides the encoded image signals to the display apparatus 21n.

The second control unit 72 communicates with a identification information displaying device 79 and provides the identification information from the HDMI decoder 711 to the identification information displaying device 79.

As described above, the identification information displaying device 79 may be a small liquid crystal display (LCD) device, for example. The second control unit 72 and the identification information displaying device 79 may communicate with each other via a USB or UART.

Meanwhile, the identification information regarding the corresponding image signal generating apparatus 20n is added to at least one of info-frame regions providing information regarding various data and unrecognized packet regions in the decoded HDMI format.

As known in the art, the information regarding various data include information regarding audio video interleave (AVI) data, information regarding source produce descriptor (SPD) data, information regarding audio data, and information regarding moving picture experts group (MPEG) data.

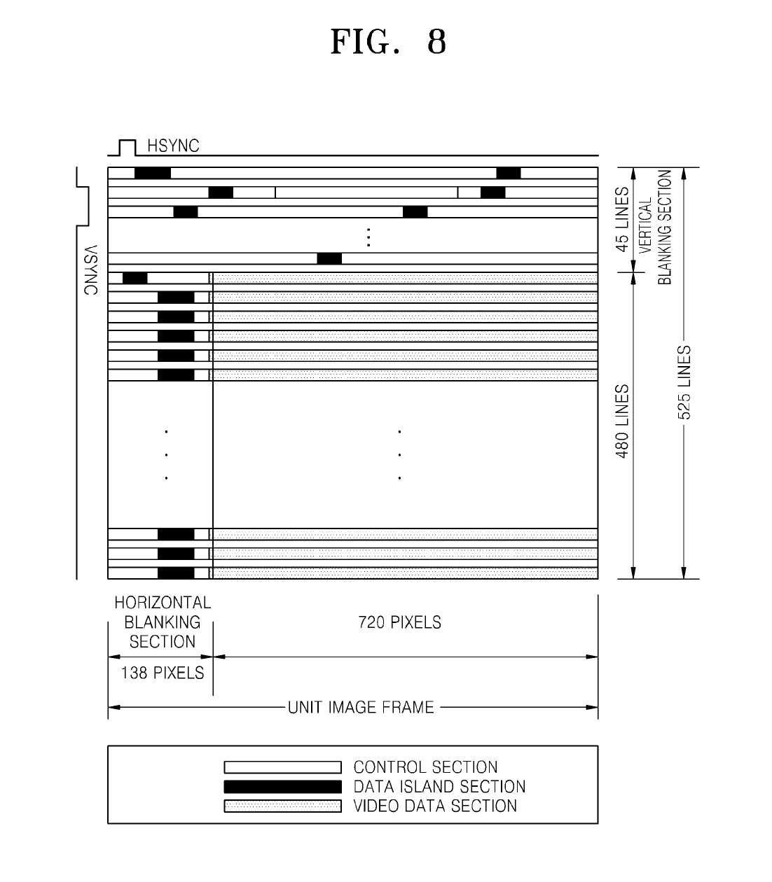

FIG. 8 shows a unit image frame of HDMI format encoded by using the TMDS method. In FIG. 8, the reference numeral VSYNC denotes a vertical synchronization signal, whereas the reference numeral HSYNC denotes a horizontal synchronization signal.

Referring to FIG. 8, a unit image frame of HDMI format encoded by using the TMDS method includes control sections, data island sections, and video data sections. Here, the identification information regarding the corresponding image signal generating apparatus 20n is added to the data island sections.

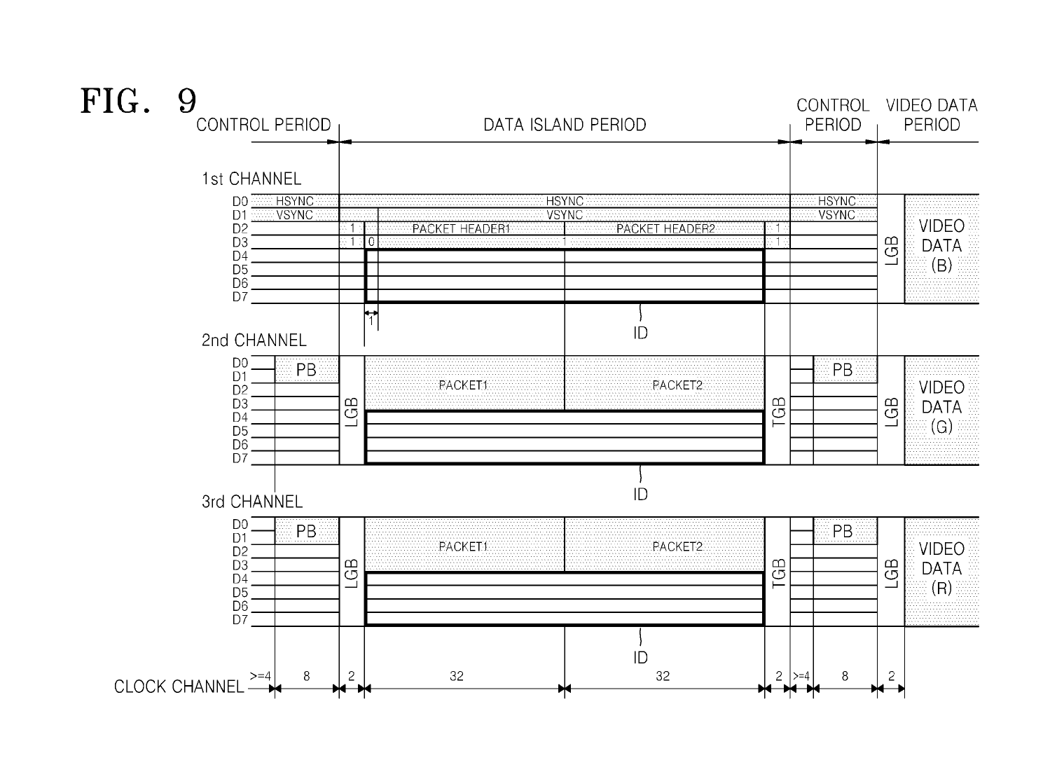

FIG. 9 shows the structure of an image signal of HDMI format encoded by using the TMDS method. In FIG. 9, the reference numeral PB denotes a premise part PB, the reference numeral LGB denotes a leading guard section, the reference numeral ID denotes an identification information recording region, and the reference numeral TGB denotes a tailing guard section.

Furthermore, video data R, video data G, and video data G denote red (R)-green (G)-blue (B) video data.

Referring to FIG. 9, an image signal of the HDMI format encoded by using the TMDS method is transmitted via 3 data channels and 1 clock channel, where a unit frame of the image signal is transmitted in the order of control period, data island period, control period, and video data period. Here, the identification information regarding the corresponding image signal generating apparatus 20n is added to data island period.

As described above, in an image system according to an embodiment of the present invention, image signals from image signal generating apparatuses are converted to image signals of a first format.

Therefore, display apparatuses may receive and display image signals of the first format only, and thus the display apparatuses may be display apparatuses of a same type.

In other words, the display apparatuses may be utilized efficiently, and it becomes easy to jointly control the display apparatuses.

Furthermore, intervention apparatuses add identification information regarding the image signal generating apparatuses to image signals of the first format according to a user input and outputs the image signals of the first format and the identification information.

Therefore, the problem in a case where the display apparatuses receive and display image signals of the first format only, that is, the problem that it is difficult for a user to determine a particular image signal generating apparatus to which a particular display apparatus is to be connected or is connected may be resolved.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An image system comprising:
image signal generating apparatuses, which generate image signals of different formats;
display apparatuses, which receive and display the image signals from the image signal generating apparatuses, respectively; and
intervention apparatuses, which are interconnected between the image signal generating apparatuses and the display apparatuses, convert the image signals from the image signal generating apparatuses to image signals of a first format, add identification information regarding the image signal generating apparatuses to the image signals of the first format, and output the image signals of the first format and the identification information, respectively.

2. The image system of claim 1, wherein each of the intervention unit comprises a transmission intervention unit and a reception intervention unit that are connected to each other,
the transmission intervention unit is connected to the corresponding one from among the image signal generating apparatuses, and
the reception intervention unit is connected to the corresponding one from among the display apparatuses.

3. The image system of claim 2, wherein the transmission intervention unit converts image signals from the corresponding image signal generating apparatus to image signals of the first format, adds identification information regarding the corresponding image signal generating apparatus to the image signals of the first format according to a user input, and transmits the image signals of the first format to the reception intervention unit, and
the reception intervention unit finds the identification information in the image signals of the first format from the transmission intervention unit, outputs the identification information, and inputs the image signals of the first format to the display apparatus.

4. The image system of claim 3, wherein the transmission intervention unit comprises:
an input image decoder, which decodes image signals from a corresponding image signal generating apparatus;
a image signal converting unit, which converts the decoded image signals from the input image decoder to image signals of the first format, adds identification information regarding the corresponding image signal generating apparatus to the image signals of the first format, and transmits the image signals of the first format to the reception intervention unit; and
a first control unit, which communicates with a user interface device and provides the identification information regarding the corresponding image signal generating apparatus to the image signal converting unit according to an input signal from the user interface device.

5. The image system of claim 4, wherein the reception intervention unit comprises:
an identification information searching unit, which finds identification information included in the image signals of the first format from the image signal converting unit of the transmission intervention unit, outputs the identification information, and provides the image signals of the first format to the display apparatus; and
a second control unit, which communicates with a identification information displaying device and provides the identification information from the identification information searching unit to the identification information displaying device.

6. The image system of claim 3, wherein image signals of the first format are image signals of high-definition multimedia interface (HDMI) format that are encoded in transition minimized differential signalling (TMDS) method.

7. The image system of claim 6, wherein the transmission intervention unit comprises:
an input image decoder, which decodes image signals from the corresponding image signal generating apparatus;
a first HDMI encoder, which converts the decoded image signals from the input image decoder to image signals of the HDMI format, adds identification information regarding the corresponding image signal generating apparatus to the image signals of the HDMI format by using the TMDS method, and transmits the image signals of the HDMI format to the reception intervention unit; and
a first control unit, which communicates with a user input apparatus and provides the identification information regarding the corresponding image signal generating apparatus to the first HDMI encoder according to an input signal from the user input apparatus.

8. The image system of claim 7, wherein the reception intervention unit comprises:
a HDMI decoder, which decodes the image signals of the HDMI format from the first HDMI encoder, finds identification information included in the image signals of the HDMI format, outputs the identification information, and outputs the decoded image signals of the HDMI format;
a second HDMI encoder, which encodes the decoded image signals of the HDMI format from the HDMI decoder by using the TMDS method and provides the encoded image signals to the display apparatus; and
a second control unit, which communicates with a identification information displaying device and provides the identification information from the HDMI decoder to the identification information displaying device.

9. The image system of claim 8, wherein the identification information regarding the corresponding image signal generating apparatus is added to at least one of info-frame regions providing information regarding various data and unrecognized packet regions in the decoded HDMI format.

10. The image system of claim 9, wherein the information regarding various data include information regarding audio video interleave (AVI) data, information regarding source produce descriptor (SPD) data, information regarding audio data, and information regarding moving picture experts group (MPEG) data.

11. The image system of claim 10, wherein a unit image frame of HDMI format encoded by using the TMDS method includes control sections, data island sections, and video data sections, and
the identification information regarding the corresponding image signal generating apparatus is added to the data island sections.

12. The image system of claim 11, wherein an image signal of the HDMI format encoded by using the TMDS method is transmitted via 3 data channels and 1 clock channel, where a unit frame of the image signal is transmitted in the order of control period, data island period, control period, and video data period, and
the identification information regarding the corresponding image signal generating apparatus is added to data island period.
